(19) United States
(12) Patent Application Publication
(10) Pub. No.: US 2026/0119423 A1
(43) Pub. Date: Apr. 30, 2026

(54) MAPPING OF TAGS TO MULTIPLE VIRTUALLY CONTIGUOUS BUFFERS FOR DIRECT DATA PLACEMENT

(71) Applicant: Chelsio Communications, Inc., Sunnyvale, CA (US)

(72) Inventor: VARUN PRAKASH, Bengaluru (IN)

(73) Assignee: Chelsio Communications, Inc., Sunnyvale, CA (US)

(21) Appl. No.: 18/925,593

(22) Filed: Oct. 24, 2024

(51) Int. Cl. G06F 13/28

(52) U.S. Cl. CPC G06F 13/28; G06F 2213/28

(57) ABSTRACT

A computing device may include a processor and a non-transitory computer-readable media storing instructions that, when executed by the processor, causes the processor to perform operations including registering multiple virtually contiguous buffers with the network adapter, allocating an ITAG, writing virtually contiguous buffer TAGs, virtual addresses and buffer lengths in a memory, inserting ITAG, buffer offset and data transfer length in the header of I/O request PDU, transmitting I/O request PDU, receiving, at the network adapter, a data packet comprising data, an indirect TAG (ITAG), buffer offset and data length within a header of the data packet, the ITAG defining a region within a memory, and fetching virtually contiguous buffer TAGs, virtual addresses, and buffer lengths from the memory based at least in part on the ITAG, determining direct memory access addresses (DMA address) of multiple virtually contiguous buffers and directly placing data in to the physical memory mapped to virtually contiguous buffers in a single tagged buffer transfer resulting in reduced CPU utilization, I/O latency and network bandwidth utilization.

### TECHNICAL FIELD

The present disclosure relates generally to data transmission between computing devices. Specifically, the present disclosure relates to systems and methods for direct data placement in multiple virtually contiguous buffers in a single tagged buffer data transfer through the use of an indirect TAG (ITAG).

### BACKGROUND

Computing networks are ubiquitously utilized to transfer data between computing devices within those networks. In some networks, direct data placement and associated protocols may be utilized. Direct data placement protocol (DDP) enables an upper layer protocol (ULP) (e.g., protocols that are located in the application-oriented layers in the open systems interconnection (OSI) model such as the layer 5 (e.g., the communication control layer), layer 6 (e.g., the presentation layer), and layer 7 (e.g., the application layer). In this state, the DDP may send data to a data-receiving computing device with an associated data storage device (e.g., a data sink) without requiring the computing device and its associated processing device (e.g., a central processing unit (CPU)) to place the data in an intermediate buffer. Therefore, when the data arrives at the computing device, the network interface such as a network adapter may place the data directly into the buffer specified by the ULP. This may enable the computing device to consume substantially less memory bandwidth than a buffered model since the computing device is not required to move the data from the intermediate buffer to the final destination. Additionally, this may enable the network protocol to consume substantially fewer CPU cycles than if the CPU was used to move the data. This may, in turn, remove a bandwidth limitation of only being able to move data as fast as the CPU may copy the data. DDP preserves a ULP record boundaries (e.g., messages) while providing a variety of data transfer mechanisms and completion mechanisms to be used to transfer ULP messages.

Thus, DDP provides information to place data received at a computing device directly into the receive buffers of the ULP without intermediate buffers. This removes excess CPU and memory utilization associated with transferring data through the intermediate buffers. A tagged buffer data transfer model requires the computing device to send the source of the transmitted data an identifier for the buffer specified by the ULP which may be referred to as a TAG or a Steering Tag (STag). A TAG may point to a single virtually contiguous buffer, and applications in this scenario cannot receive data in multiple virtually contiguous buffers in a single tagged buffer data transfer. To receive data in multiple virtually contiguous buffers, user space applications may post one tagged buffer data transfer request for each virtually contiguous buffer. This increases CPU utilization, input/output (I/O) latency, and network bandwidth utilization.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a block diagram of an indirect TAG (ITAG) within a direct data placement protocol (DDP) computing environment, according to an example of the principles described herein.

FIG. 2 illustrates a computer architecture diagram showing a computing device, according to an example of the principles described herein.

FIG. 3 illustrates diagram of a data packet including the ITAG within a header, according to an example of the principles described herein.

FIG. 4 illustrates a packet transfer diagram including an input/output (I/O) request and data packet that are transmitted with the ITAG, according to an example of the principles described herein.

FIG. 5 illustrates a flow diagram of an example method of DDP, according to an example of the principles described herein.

FIG. 6 illustrates a flow diagram of an example method of DDP, according to an example of the principles described herein.

FIG. 7 illustrates a flow diagram of an example method of DDP, according to an example of the principles described herein.

FIG. 8 illustrates a block diagram of an example packet switching device (or system) that can be utilized to implement various aspects of the technologies disclosed herein.

FIG. 9 illustrates a block diagram of components of an example node that may be utilized to implement various aspects of the technologies disclosed herein.

FIG. 10 illustrates a computing system diagram illustrating a configuration for a data center that may be utilized to implement aspects of the technologies disclosed herein.

### DESCRIPTION OF EXAMPLE EMBODIMENTS

### Overview

The present disclosure describes receiving data in multiple virtually contiguous buffers in a single tagged buffer data transfer through the utilization of an indirect TAG (ITAG). The present systems and methods may utilize one or more of a number of technologies, systems, and methods described in request for comments (RFCs) that define Internet wide area remote direct memory access (RDMA) protocol (iWARP), Internet small computer systems interface (iSCSI), and NVM Express (NVMe)/Transmission Control Protocol (TCP) (NVMe/TCP). For example, RFC 5040 titled, “A Remote Direct Memory Access Protocol Specification” is layered over Direct Data Placement (DDP) and defines how RDMA Send, Read, and Write operations are encoded using DDP into headers on the network. RFC 5041 titled, “Direct Data Placement over Reliable Transports is layered over MPA/TCP or SCTP” defines how received data can be directly placed into an upper layer protocols (ULP) receive buffer without intermediate buffers. RFC 5042 titled, “Direct Data Placement Protocol (DDP)/Remote Direct Memory Access Protocol (RDMAP) Security” analyzes security issues related to iWARP DDP and RDMAP protocol layers. RFC 5043 titled, “Stream Control Transmission Protocol (SCTP) Direct Data Placement (DDP) Adaptation” defines an adaptation layer that enables DDP over SCTP. RFC 5044 titled, “Marker PDU Aligned Framing for TCP Specification” defines an adaptation layer that enables preservation of DDP-level protocol record boundaries layered over the TCP reliable connected byte stream.

DDP supports two data transfer models including a tagged buffer data transfer model (e.g., using TAGs) and an untagged buffer data transfer model. The tagged buffer data transfer model requires the data-receiving computing device with an associated data storage device (e.g., a data sink) to send a data-transmitting computing device with an associated data storage device (e.g., a data source) an identifier for the application buffer specified by the ULP, referred to as a TAG or a Steering Tag (STag). The TAG, buffer offset and data transfer length are transferred to the data source using a ULP-defined method. Once the data source ULP has a TAG, buffer offset and data transfer length for a destination application buffer specified by the ULP, the data source may request that DDP send the ULP data to the application buffer specified by the ULP by specifying the TAG, buffer offset and data length to DDP.

In contrast, the untagged buffer data transfer model enables data transfer to occur without requiring the data sink to advertise the application buffer specified by the ULP to the data source. The data sink may queue up a series of application buffers specified by the ULP. An untagged DDP message from the data source may consume an untagged buffer at the data sink. Because DDP is message oriented, even if the data source sends a DDP message payload smaller than the application buffer specified by the ULP, the partially filled application buffer specified by the ULP may be delivered to the ULP anyway. If the data source sends a DDP message payload larger than the application buffer specified by the ULP, it may result in an error.

A computer operating system (OS) may utilize virtual memory to provide separate address spaces referred to as user space and kernel space. This separation serves to provide memory protection and hardware protection from malicious or errant software behavior. Kernel space is strictly reserved for running a privileged OS kernel, kernel extensions, and most device drivers. In contrast, user space is the memory area where application software and some drivers execute and may be allocated one address space per process. Stated another way, user space refers to the various programs and libraries that the OS utilizes to interact with the kernel.

For direct data placement, user space applications that utilize iWARP, iSCSI, and NVMe/TCP may register virtually contiguous buffers with a network adapter. On successful registration, the iWARP, iSCSI and NVMe/TCP driver returns a TAG to the application. For data transfer, the application executed on the data-receiving computing device sends this TAG, buffer offset and data transfer length to a peer such as the data-transmitting computing device. While sending the data, the data-transmitting computing device fills this TAG, buffer offset and data length in a protocol header of a protocol data unit (PDU). On receiving the data of the PDU, the network adapter of the data-receiving computing device may use this TAG for determining DMA addresses of application buffers to place data directly into the application buffers.

However, as a TAG points to a single virtually contiguous buffer, applications cannot receive data in multiple virtually contiguous buffers in a single tagged buffer data transfer. To receive data in multiple virtually contiguous buffers, user space applications may post one tagged buffer data transfer request for each virtually contiguous buffer. While this make it possible to receive data in multiple virtually contiguous buffers, this increases CPU utilization, I/O latency and network bandwidth utilization.

Therefore, the present systems and methods utilize direct data placement (e.g., direct memory access (DMA)) through the utilization of an indirect TAG (ITAG) to ensure reduced CPU overhead by directly moving data from the wire to multiple virtually contiguous application buffers with no extra data copies being made in a single tagged buffer data transfer. An application registers multiple virtually contiguous buffers with the network adapter (this registration is done only once at the start of the application), application allocates an ITAG for receiving data in multiple virtually contiguous buffers in a single tagged buffer data transfer. An ITAG may define an ITAG region which may be defined as special region in a memory (network adapter or computing device memory). The ITAG region may be divided in variable size units where each unit has an index. This index is used as the ITAG. The application may write a TAG field, a virtual address field, and a length field for all the virtually contiguous buffers in the region. The application may then fill the ITAG, buffer offset and data transfer length in a PDU header of an I/O request and send the PDU to the data-transmitting computing device. The data-transmitting computing device fills the ITAG, buffer offset and data length in each data PDU header for the I/O. On receiving a PDU including data, the network adapter uses the ITAG in the protocol header as an index to fetch all the virtually contiguous buffer TAGs, virtual addresses, and buffer lengths from the memory. Using virtually contiguous buffer TAGs and virtual addresses, the network adapter determines DMA addresses of the application buffers and directly places the data into the application buffers.

Examples described herein provide a non-transitory computer-readable medium storing instructions that, when executed, causes a processor to perform operations, including registering multiple virtually contiguous buffers with network adapter, allocating an indirect TAG (ITAG), the ITAG defining a region within a memory, and inserting the ITAG, buffer offset and data transfer length into a header of an I/O request packet and data packet. The operations further include transmitting the data packet including data to a computing device, and, at the computing device, utilizing the ITAG as an index, fetching virtually contiguous buffer TAGs, virtual addresses, and buffer lengths from a memory, and determining direct memory access (DMA) addresses of virtual memory buffers to directly place the data into the physical memory based at least in part on the virtually contiguous buffer TAGs and the virtual addresses.

Transmitting the data packet may include transmitting the data packet including the ITAG, buffer offset and data length as a single tagged buffer data transfer. The ITAG region includes a plurality of variable-size units of the memory. The plurality of variable-size units may include an index defining the ITAG. The ITAG includes data defining an index to fetch virtually contiguous buffer TAGs, virtual addresses, and buffer lengths from the memory.

Examples described herein also provide a computing device including a network adapter, a processor communicatively coupled to the network adapter, and a non-transitory computer-readable media storing instructions that, when executed by the processor, causes the processor to perform operations. The operations may include receiving, at the network adapter, a data packet including data, an indirect TAG (ITAG), buffer offset and data length within the data packet, the ITAG defining a region within a memory, filling the ITAG, buffer offset and data length in a plurality of protocol data units (PDUs).

The network adapter may further include a direct data placement (DDP) module, the operations may further include, with the DDP module, fetching virtually contiguous buffer TAGs, virtual addresses and buffer lengths from the memory based at least in part on the ITAG, determining direct memory access (DMA) addresses of virtual memory buffers to directly place the data into the physical memory based at least in part on the virtually contiguous buffer TAGs and the virtual addresses.

The data packet may include the ITAG, buffer offset and data length inserted into a header of the data packet. The receiving of the data packet may include receiving the data packet including the ITAG, buffer offset and data length as a single tagged buffer data transfer. The ITAG region may include a plurality of variable-size units of the memory of the network adapter or computing device memory. The plurality of variable-size units may include an index defining the ITAG. The ITAG includes data defining an index to fetch virtually contiguous buffer TAGs, virtual addresses, and buffer lengths from the memory of the network adapter or computing device memory.

Examples described herein also provide a network adapter may to perform operations. The operations may include receiving, at the network adapter, a data packet including data, an indirect TAG (ITAG), buffer offset and data length within a header of the data packet, the ITAG defining a region within a memory, filling the ITAG, buffer offset and data length in a plurality of protocol data units (PDUs).

The network adapter may include a direct data placement (DDP) module, the operations may further include, with the DDP module, fetching virtually contiguous buffer TAGs, virtual addresses and buffer lengths from the memory based at least in part on the ITAG, determining direct memory access (DMA) addresses of virtual memory buffers to directly place the data into the physical memory based at least in part on the virtually contiguous buffer TAGs and the virtual addresses. The virtually contiguous buffers described herein may be represented by a range of user-space virtual addresses, and the contents of the virtually contiguous buffers may be stored on multiple physically discontiguous pages included in physical memory.

Thus, DMA is a feature of computer systems that allows certain hardware subsystems such as the network adapter described herein to access main system memory independently of the CPU and transfer data directly to or from the main memory. This direct pathway frees the CPU from the heavy lifting of data transfer tasks and enables the CPU to focus on other processing activities. The efficiency of DMA is evident in scenarios requiring high-speed data transfers and storage, where minimizing CPU overhead is a priority. Without DMA, when the CPU is using programmed input/output, the CPU may be fully occupied for the entire duration of the read or write operation and is thus unavailable to perform other processes. With DMA, however, the CPU may first initiate the transfer, and then perform other operations while the transfer is in progress and the CPU finally receives an interrupt from a DMA controller (DMAC) when the operation is completed. This feature is useful at any time that the CPU cannot keep up with the rate of data transfer or when the CPU needs to perform work while waiting for a relatively slow I/O data transfer. Many hardware systems use DMA, including the above-mentioned network adapter as well as disk drive controllers, graphics cards, and sound cards. DMA may also be used for intra-chip data transfer in some multi-core processors. Computers that have DMA channels may transfer data to and from devices with much less CPU overhead than computers without DMA channels. Similarly, a processing circuitry inside a multi-core processor may transfer data to and from its local memory without occupying its processor time, allowing computation and data transfer to proceed in parallel.

In a DMA operation, the CPU may initialize the transfer by specifying the source and destination addresses and the amount of data to be transferred. Once the DMA controller is configured, the DMA controller handles the data transfer directly between the peripherals and memory, signaling the CPU upon completion. This process significantly reduces the CPU's workload, enhancing the overall system performance, especially in data-intensive operations.

However, DMA technology may only facilitate data transfer between internal devices within the same computer and may not achieve direct memory access between other computers. Thus, RDMA goes a step further by extending the principles of DMA across computer networks such as the data-transmitting computing device and the data-receiving computing device described herein. RDMA enables one computing device to access the memory of another computing device directly, without involving the CPU, operating system, or cache of either computing devices. RDMA is designed to achieve ultra-low latency and high throughput data transfers, which are crucial in high-performance computing environments, large data centers, and applications requiring rapid, efficient data movement.

RDMA achieves its efficiency by bypassing a traditional network stack. When an RDMA-capable network adapter is used, data may be transferred directly from the memory of one computer to another over the network with minimal CPU intervention. This direct transfer path significantly reduces latency and increases data transfer speeds, making RDMA an ideal choice for distributed computing scenarios where performance and efficiency are paramount.

The data packet may include the ITAG, buffer offset and data length inserted into a header of the data packet. Transmitting the data packet may include transmitting the data packet including the ITAG, buffer offset and data length, as a single tagged buffer data transfer. The ITAG region may include a plurality of fixed variable-size units of the memory of the network adapter or computing device memory. The plurality of variable-size units may include an index defining the ITAG. The ITAG may include data defining an index to fetch virtually contiguous buffer TAGs, virtual addresses, and buffer lengths from the memory of the network adapter or computing device memory.

Additionally, the techniques described in this disclosure may be performed as a method and/or by a system having non-transitory computer-readable media storing computer-executable instructions that, when executed by one or more processors, performs the techniques described herein. Further, techniques described in this disclosure may be implemented in the hardware of the network adapter.

### EXAMPLE EMBODIMENTS

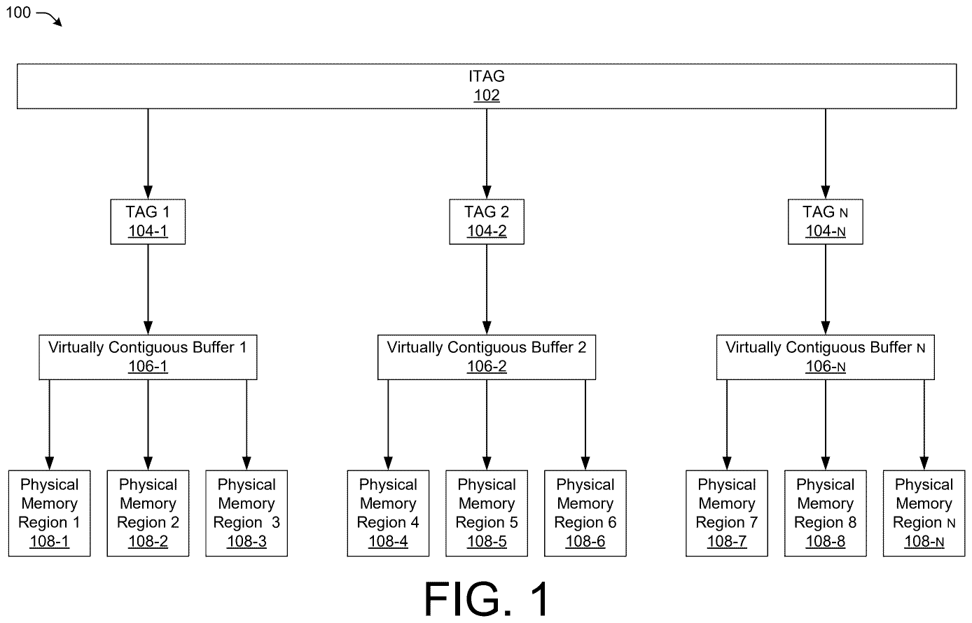

This disclosure describes techniques for mapping a TAG to multiple virtually contiguous buffers for direct data placement via the use of an indirect TAG (ITAG). FIG. 1 illustrates a block diagram of an indirect TAG (ITAG) within a direct data placement protocol (DDP) computing environment 100, according to an example of the principles described herein. The DDP computing environment 100 may include any computing environment wherein DDP allows the efficient placement of data into virtually contiguous buffers 106-1, 106-2, . . . 106-N (collectively referred to herein as virtually contiguous buffer(s) 106) designated by protocols layered above DDP, where N is any integer greater than or equal to 1. Efficiency in this sense may be characterized by the minimization of the number of transfers of the data over the receiving device's system buses, reduction or elimination of the utilization of the CPU, a reduction in input/output (I/O) latency, and/or a reduction in network bandwidth utilization.

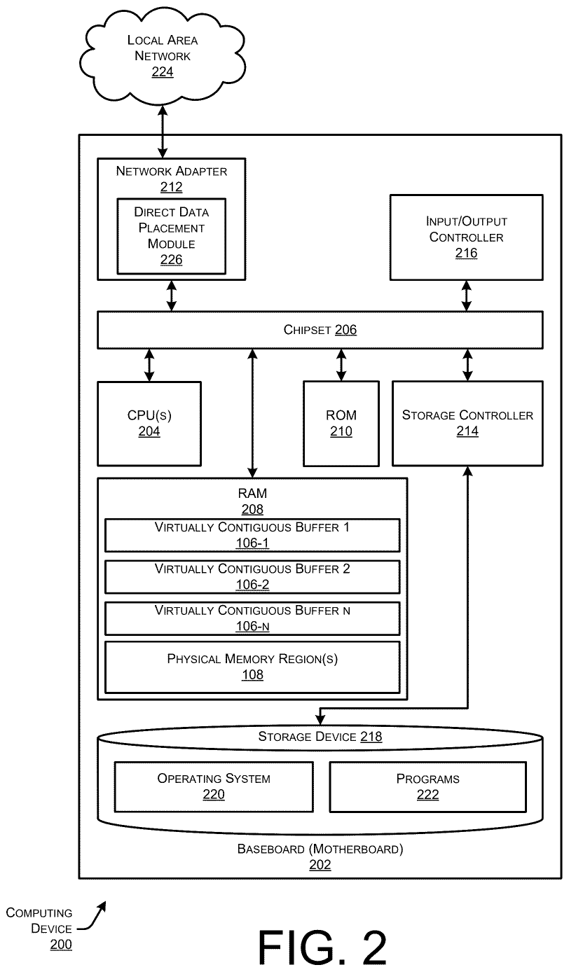

A central idea of general-purpose DDP is that the data-transmitting computing device may supplement the data it sends with placement information that allows the network interface (e.g., the network adapter 212 of FIG. 2) of the data-receiving computing device to place the data directly at its final destination in memory of the data-receiving computing device without any copying. DDP can be used to steer received data to this final destination without requiring layer-specific behavior for each different layer. Data sent with such DDP information is said to be ‘tagged’ and may include one or more TAGs as described herein. The components of the DDP architecture may include the ‘buffer’ which is an object with beginning and ending addresses, and a method (set( )) which sets the value of an octet at an address. The virtually contiguous buffers 106 may correspond directly to a portion of the memory (e.g., the RAM 208 of FIG. 2) of the data-receiving computing device. However, DDP may not depend on this and a virtually contiguous buffers 106 may be a disk file, or anything else that can be viewed as an addressable collection of octets.

As depicted in FIG. 1, the virtually contiguous buffers 106 may be associated with a plurality of physical memory regions 108-1, 108-2, 108-3, 108-4, 108-5, 108-6, 108-7, 108-8, . . . 108-N (collectively referred to herein as physical memory region(s) 108), where N is any integer greater than or equal to 1. A plurality of TAGs 104-1, 104-2, . . . 104-N (collectively referred to herein as TAG(s) 104) may be used to identify the virtually contiguous buffers 106, where N is any integer greater than or equal to 1. The DDP computing environment 100 may further include the ITAG 102 as described herein. The ITAG 102 may be allocated by an application executed on the data-receiving computing device and may define a special region in a memory; virtually contiguous buffer TAGs, virtual addresses and buffer lengths for all the virtually contiguous buffers 106 where the data transmitted with the ITAG is to be directly placed are stored in this region. The region defined by the ITAG may be referred to as the ITAG region and may be divided into variable-size units where each variable-size unit has an index associated therewith. This index serves as the ITAG. The application writes the TAG(s), virtual address(es), and length field(s) for all the virtually contiguous buffers 106 in this ITAG region. The application fills the ITAG, buffer offset and data transfer length in a header of a PDU of an I/O request and sends the PDU to the data-transmitting computing device. The data-transmitting computing device may include the ITAG, buffer offset and data length in each data PDU for the I/O request. On receiving a PDU and its associated data, the network adapter (e.g., the network adapter 212 of FIG. 2) may utilize the ITAG in the header of the PDU as an index to fetch all the TAGs 104, virtual addresses within the virtually contiguous buffers 106, and lengths from a memory of the network adapter (e.g., the network adapter 212 of FIG. 2) or computing device memory (e.g., RAM 208 of FIG. 2). Using the TAGs 104 and the virtual addresses within the virtually contiguous buffers 106, the network adapter (e.g., the network adapter 212 of FIG. 2) may identify DMA addresses of the virtually contiguous buffers 106 and directly place the data sent in the PDU into the physical memory regions 108 associated with the virtually contiguous buffers 106.

FIG. 2 illustrates a computer architecture diagram showing a computing device 200, according to an example of the principles described herein. The computing device 200 may include the data-transmitting computing device and/or the data-receiving computing device described herein. FIG. 2 shows an example computer architecture for the computing device 200 capable of executing program components for implementing the functionality described above. The computer architecture shown in FIG. 2 illustrates a conventional server computer, workstation, desktop computer, laptop, tablet, network appliance, e-reader, smartphone, or other computing device, and may be utilized to execute any of the software and/or hardware components presented herein. The computing device 200 may, in one example, correspond to a physical server of a data center, a packet switching system, and/or a node within a computing network as described herein.

The computing device 200 may include a baseboard 202, or “motherboard,” which is a printed circuit board to which a multitude of components or devices may be connected by way of a system bus or other electrical communication paths. In one illustrative configuration, one or more central processing units (“CPUs”) 204 may operate in conjunction with a chipset 206. The CPUs 204 may be standard programmable processors that perform arithmetic and logical operations necessary for the operation of the computing device 200.

The CPUs 204 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 206 provides an interface between the CPUs 204 and the remainder of the components and devices on the baseboard 202. The chipset 206 may provide an interface to a RAM 208, used as the main memory in the computing device 200. The chipset 206 may further provide an interface to a computer-readable storage medium such as a read-only memory (“ROM”) 210 or non-volatile RAM (“NVRAM”) for storing basic routines that help to start up the computing device 200 and to transfer information between the various components and devices. The ROM 210 or NVRAM may also store other software components necessary for the operation of the computing device 200 in accordance with the configurations described herein.

The computing device 200 may operate in a networked environment using logical connections to remote computing devices and computer systems (e.g., between the data-transmitting computing device and the data-receiving computing device) through a network, such as the local area network (LAN) 224. The chipset 206 may include functionality for providing network connectivity through a network adapter 212, such as a gigabit Ethernet adapter. The network adapter 212 may be capable of connecting the computing device 200 to other computing devices over the network 224. Multiple network adapters 212 may be present in the computing device 200, connecting the computer to other types of networks and remote computer systems.

The computing device 200 may be connected to a storage device 218 that provides non-volatile storage for the computing device 200. The storage device 218 may store an operating system 220, programs 222, and data, which are described in greater detail herein. The storage device 218 may be connected to the computing device 200 through a storage controller 214 connected to the chipset 206. The storage device 218 may include one or more physical storage units. The storage controller 214 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 200 may store data on the storage device 218 by transforming the physical state of the physical storage units to reflect the information being stored. The specific transformation of physical state may depend on various factors, in different examples within this description. Examples of such factors may include, but are not limited to, the technology used to implement the physical storage units, whether the storage device 218 is characterized as primary or secondary storage, and the like.

For example, the computing device 200 may store information to the storage device 218 by issuing instructions through the storage controller 214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 200 may further read information from the storage device 218 by detecting the physical states or characteristics of one or more particular locations within the physical storage units.

In addition to the mass storage device 218 described above, the computing device 200 may have access to other computer-readable storage media to store and retrieve information, such as program modules, data structures, or other data. It should be appreciated by those skilled in the art that computer-readable storage media is any available media that provides for the non-transitory storage of data and that may be accessed by the computing device 200. In one example, the operations performed by a computing resource network, and/or any components included therein, may be supported by one or more devices similar to computing device 200. Stated otherwise, some or all of the operations performed by a computing resource network and/or any components included therein, may be performed by one or more computing device 200 operating in a cloud-based arrangement.

By way of example, and not limitation, computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that may be used to store the desired information in a non-transitory fashion.

As mentioned briefly above, the storage device 218 may store an operating system 220 utilized to control the operation of the computing device 200. According to one example, the operating system comprises the LINUX operating system. According to another example, the operating system comprises the WINDOWS® SERVER operating system from MICROSOFT Corporation of Redmond, Washington. According to further examples, the operating system may comprise the UNIX operating system or one of its variants. It should be appreciated that other operating systems may also be utilized. The storage device 218 may store other system or application programs and data utilized by the computing device 200.

In one example, the storage device 218 or other computer-readable storage media may be encoded with computer-executable instructions which, when loaded into the computing device 200, transform the computer from a general-purpose computing system into a special-purpose computer capable of implementing the examples described herein. These computer-executable instructions transform the computing device 200 by specifying how the CPUs 204 transition between states, as described above. According to one example, the computing device 200 has access to computer-readable storage media storing computer-executable instructions which, when executed by the computing device 200, perform the various processes described herein. The computing device 200 may also include computer-readable storage media having instructions stored thereupon for performing any other computer-implemented operations described herein.

The computing device 200 may also include one or more input/output controllers 216 for receiving and processing input from a number of input devices, such as a keyboard, a mouse, a touchpad, a touch screen, an electronic stylus, or other type of input device. Similarly, an input/output controller 216 may provide output to a display, such as a computer monitor, a flat-panel display, a digital projector, a printer, or other type of output device. It will be appreciated that the computing device 200 may not include all of the components shown in FIG. 2, may include other components that are not explicitly shown in FIG. 2, or might utilize an architecture completely different than that shown in FIG. 2.

The virtually contiguous buffers 106 and/or the physical memory regions 108 may be included within the RAM 208 of the computing device 200 as depicted in FIG. 2. However, either or both of the virtually contiguous buffers 106 and the physical memory regions 108 may be included within other devices within the computing device 200 such as, for example, the network adapter 212, Solid State Drives (SSD). The location of the virtually contiguous buffers 106 and/or the physical memory regions 108 may be dependent on the final destination where the data within a PDU is to be stored.

Further, the network adapter 212 may include direct data placement (DDP) module 226 may, when executed by the network adapter 212 or other data processing device within the computing device 200, perform a number of processes after receiving the data packet from another computing device 200. For example, the network adapter 212 may receive the data packet including data and the ITAG, buffer offset and data length included within the header of the data packet. With the network adapter 212, the DDP module 226 may fetch virtually contiguous buffer TAGs, virtual addresses, and buffer lengths from the memory based at least in part on the ITAG. Further, the DDP module 226 may, when executed by the network adapter 212 or other data processing device within the computing device 200, determine direct memory access (DMA) addresses of the virtually contiguous buffers 106 to directly place the data into the physical memory based at least in part on the virtually contiguous buffer TAGs and the virtual addresses obtained from the ITAG 102.

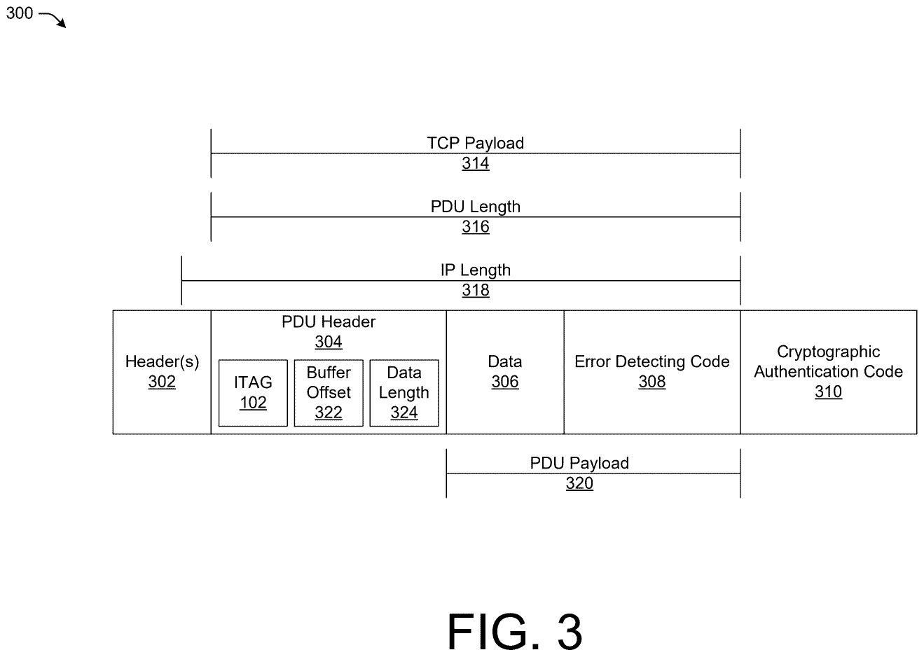

FIG. 3 illustrates diagram of a data packet 300 including the ITAG 102, a buffer offset 322 and a data length 324 within a header 304, according to an example of the principles described herein. FIG. 3, depicts a Transmission Control Protocol/Internet Protocol (TCP/IP) frame that includes headers 302, TCP payload 314 that has a length equivalent to a PDU length 316, and a cryptographic authentication code (CRC) 310 at the end of the frame. Further, the data packet 300 may include an IP length 318. The TCP payload may include a PDU that is aligned with the start of the TCP payload 314. The PDU header 304 may include the ITAG 102, buffer offset, data length and the ITAG region may include TAG, virtual address and length field for a plurality of associated virtually contiguous buffers 106 that may be used to look up in a mapping table where the PDU payload 320 (e.g., the DMA payload) is to be placed within the virtually contiguous buffers 106 and/or the associated physical memory regions 108. A CRC code 260 may be included at the end of the PDU which may be computed over PDU payload or over the whole PDU contents. In one example, the data packet 300 may optionally contain a cryptographic authentication code such as an SHA-256 hash. The authentication hash may be either stored in an IP datagram pad or the packet length may be extended to include the SHA-256 hash. Further, the PDU header may be included as part of the PDU payload 320 along with data 306 for transmission and the error detecting code 308. Although the data packet 300 depicted in FIG. 3 may include fewer or more elements, the data packet 300 includes the ITAG 102, buffer offset and data length within, for example, the PDU header 304 or other header to allow for the processes described herein.

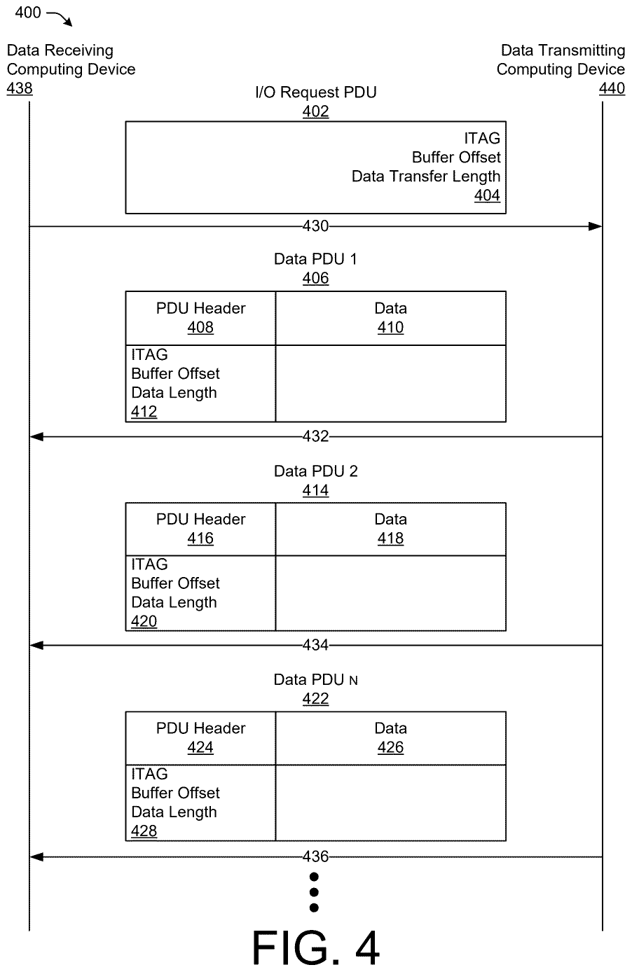

FIG. 4 illustrates a packet transfer diagram 400 including an input/output (I/O) request and data packet 300 that are transmitted with the ITAG 102, according to an example of the principles described herein. FIG. 4 presents an overview how an I/O request and a data packet may be transmitted with an ITAG. A number of data packets may be transferred between a data transmitting computing device 440 and a data receiving computing device 438. In doing so, a I/O request PDU 402 may be transmitted from the data receiving computing device 438 to the data transmitting computing device 440 at 430. The I/O request PDU 402 may include an ITAG, buffer offset and data transfer length 404. Once received, the data transmitting computing device 440 may then transmit, at 432, a first data PDU (e.g., data PDU 1 406). The data PDU 1 406 may include a PDU header 408, data 410, and ITAG, buffer offset and data length 412, among other elements.

At 434, the data transmitting computing device 440 may then transmit a second or subsequent data PDU (e.g., data PDU 2 414). The data PDU 2 414 may include a PDU header 416, data 418, and ITAG, buffer offset and data length 420, among other elements. Similarly, at 436, the data transmitting computing device 440 may then transmit a third or subsequent data PDU (e.g., data PDU N 422). The data PDU N 422 may include a PDU header 424, data 426, and an ITAG, buffer offset and data length 428, among other elements. Any number of data PDUs may be transmitted by the data transmitting computing device 440 as indicated by the ellipsis depicted at the bottom of FIG. 4.

With the above description of the ITAG within the DDP computing environment 100, the computing device 200 including the network adapter 212 and the DDP module 226, and the data packet 300 including the ITAG 102, buffer offset, and data length, example methods of how the ITAG may be used in the mapping of TAGs to multiple virtually contiguous buffers 106 for DDP will now be described. According to an example of the principles described herein. The method may include with a data-receiving computing device that includes the capabilities of the computing device 200 of FIG. 2, registering virtually contiguous buffers with the network adapter, allocating an ITAG for an I/O request packet 300 to be sent to a data-transmitting computing device that includes the capabilities of the computing device 200 of FIG. 2. In one example, an application on the data-receiving computing device may be executed to cause the allocation of the ITAG for the I/O request packet 300 being transmitted. That application may be associated with the DDP module 226 of the network adapter 212.

The allocation of the ITAG 102 may include the association of the ITAG 102 with a region within a memory such as network adapter memory or computing device memory. The region may be divided in variable-size units where each unit has an index. This index serves as the ITAG 102. The network adapter 212 or the application at data-receiving computing device may write the TAGs, virtual addresses, and buffer lengths for all the virtually contiguous buffers 106 in this region as the information or data defining the buffer where network adapter has to write the data.

The network adapter 212 or the application at data-receiving computing device may insert ITAG, buffer offset and data transfer length into the header of an I/O request PDU 402 and send this PDU to data-transmitting computing device.

Data-transmitting computing device receives I/O request PDU, the network adapter or the application at data-transmitting computing device may insert the ITAG 102, buffer offset and data length into a header such as the PDU header 304 of the TCP payload 314 of the data packet 300. In one example, the ITAG 102 may be placed anywhere within the data packet 300 as may be beneficial for obtaining the TAGs, virtual addresses, and buffer lengths for all the virtually contiguous buffers 106. In this manner, the ITAG 102 may be included within the data packet 300 in order to utilize the ITAG in the mapping of TAGs to multiple virtually contiguous buffers 106 for DDP. Data-transmitting computing device sends data PDU to data-receiving computing device.

Network adapter 212 at data-receiving computing device receives data PDU, network adapter may read ITAG from the data PDU header and DDP module 226 of network adapter 212 may utilize ITAG as an index to fetch virtually contiguous buffer TAGs, virtual addresses and buffer lengths from the network adapter memory or computing device memory.

DDP module 226 of the network adapter 212 at data-receiving computing device may determine direct memory access (DMA) addresses of virtually contiguous buffers and directly places (e.g., via DMA write process) the data into the physical memory mapped to virtually contiguous buffers.

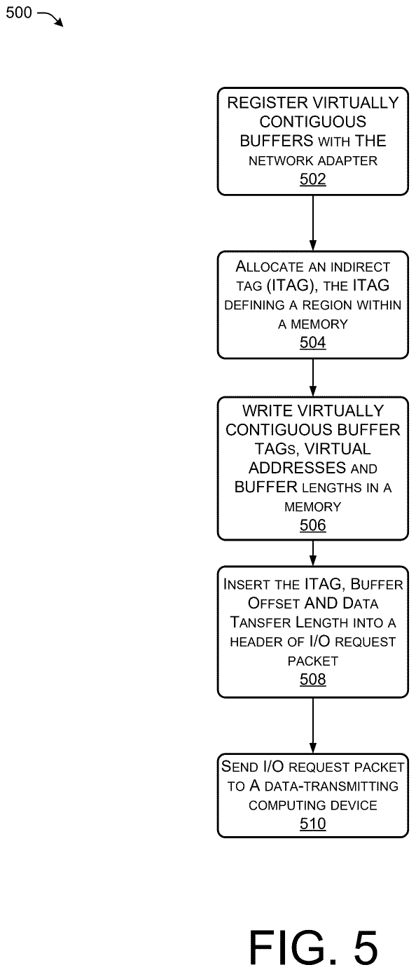

FIG. 5 illustrates a flow diagram of an example method 500 of DDP, according to an example of the principles described herein. At 502, the virtually contiguous buffers may be registered with the network adapter 212. In one example, the computing device 200 may perform the process(es) of 502. Further, in one example, the virtually contiguous buffers may be registered with the network adaptor 212 as an initial one-time process and/or may do so during the start of the application.

At 504, the ITAG may be allocated in association with the virtually contiguous buffers. The ITAG defines a region within a memory such as, for example, the network adapter memory or computing device memory. At 506, the computing device 200 may write the virtually contiguous buffer TAGs, virtual addresses, and buffer lengths in the memory region defined by ITAG. The ITAG, buffer offset and data transfer length may be inserted into the header of I/O request packet (e.g., the I/O request PDU 402) at 508. At 510, the I/O request packet (e.g., the I/O request PDU 402) may be sent to the data-transmitting computing device 440.

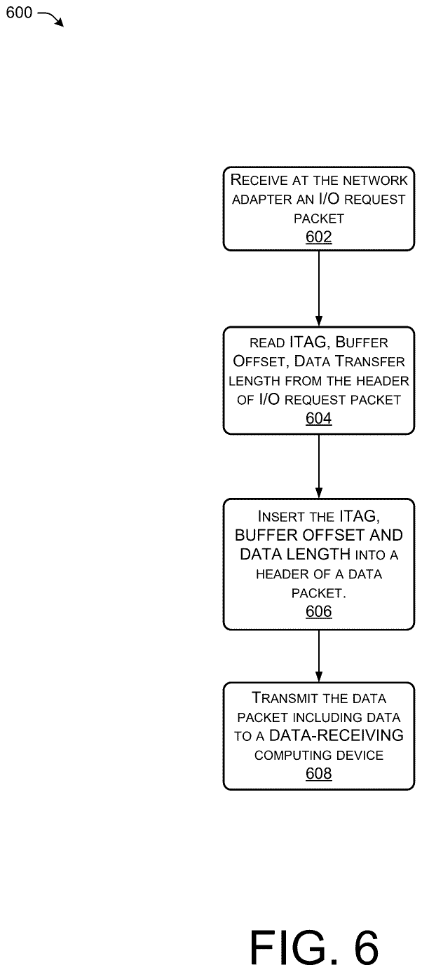

FIG. 6 illustrates a flow diagram of an example method 600 of DDP, according to an example of the principles described herein. The method 600 of FIG. 6 may include, at 602, receiving, at the network adapter 212, of the data-transmitting computing device 440, an I/O request packet (e.g., the I/O request PDU 402). The I/O request packet (e.g., the I/O request PDU 402) may be read including the ITAG, the buffer offset, and the data transfer length from the header of I/O request packet (e.g., the I/O request PDU 402).

At 606 and with a data-transmitting computing device that includes the capabilities of the computing device 200 of FIG. 2, an ITAG, buffer offset and data length may be inserted in a data packet 300 to be sent to a data-receiving computing device (e.g., the data-receiving computing device 438) that includes the capabilities of the computing device 200 of FIG. 2 as similarly described above. Further, as similarly described above, 0061 the network adapter or the application may insert the ITAG 102, buffer offset and data length into a header such as the PDU header 304 of the TCP payload 314 of the data packet 300.

At 608, the data packet 300 may be transmitted to the data-receiving computing device (e.g., data-receiving computing device 438) with the data packet 300 such as at 432, 434, and 436 of FIG. 4 including the data 306 and the ITAG 102, buffer offset and data length.

In one example, upon receiving the data packet 300 the DDP module 226 of the network adapter 212 at data-receiving computing device may utilize the ITAG as an index to fetch the TAGs, virtual addresses, and buffer length fields for all the virtually contiguous buffers 106 from the network adapter memory or computing device memory. Further, the DDP module 226 of the network adapter 212 may be utilized to determine the direct memory access (DMA) addresses of the virtually contiguous buffers 106 to directly place the data into the physical memory based at least in part on the virtually contiguous buffer TAGs and the virtual addresses.

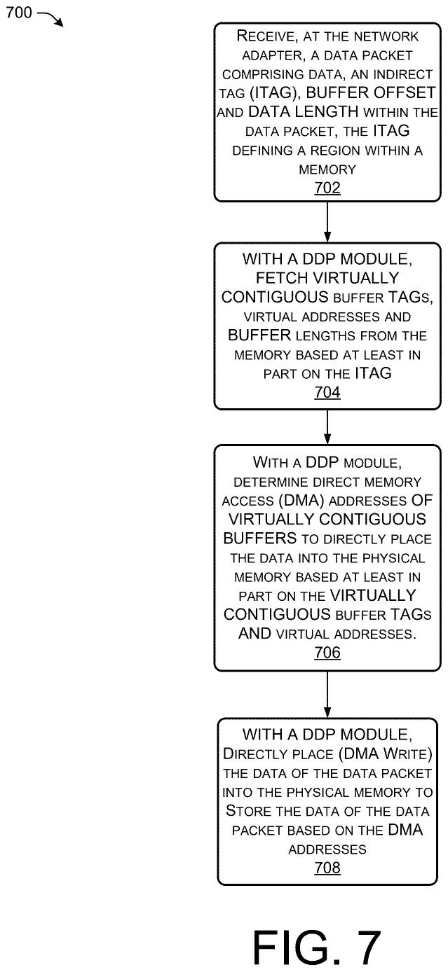

FIG. 7 illustrates a flow diagram of an example method 700 of DDP, according to an example of the principles described herein. The method 700 of FIG. 7 may include processing performed by a data-receiving computing device as described herein. At 702, the method 700 may include receiving, at the network adapter 212, the data packet comprising data, an indirect TAG (ITAG), buffer offset, and data length within a header of the data packet 300, the ITAG 102 defining a region within a memory such as the network adapter memory or computing device memory.

At 704, the method may include, with the DDP module 226 fetching virtually contiguous buffer TAGs, virtual addresses, and buffer lengths from the memory based at least in part on the ITAG received with the data packet 300 at 704.

Further, at 706, the method 600 may include, with the DDP module 226, determining direct memory access (DMA) addresses of the virtually contiguous buffers to directly place the data into the physical memory (e.g., the RAM 208) at the physical memory regions 108 based at least in part on the virtually contiguous buffer TAGs and the virtual addresses obtained from the ITAG. With this information, the network adapter 212 executing the DDP module 226, may store the data 306 included in the data packet 300 in the virtually contiguous buffers 106 and/or the physical memory regions 108 based at least in part on the DMA addresses of the virtually contiguous buffers identified by the ITAG and the virtually contiguous buffer TAGs and virtual addresses identified thereby. Thus, at 708, the network adapter 212 with the DDP module 216 may directly place (e.g., via a DMA write process) the data of the data packet 300 into the physical memory to store the data packet based on the DMA addresses.

Thus, with the use of the ITAG 102, the network adapter 212 executing the DDP module 226 may receive data in multiple virtually contiguous buffers 106 and post a single tagged buffer data transfer requests for the plurality of virtually contiguous buffers 106. This significantly decreases CPU utilization, I/O latency, and network bandwidth utilization.

The methods described herein may utilize a number of protocols and processes associated with those protocols. Several examples will now be described.

Usage of iTAG for Direct Data Placement (DDP) in iWARP

For Direct Data Placement (DDP) in multiple virtually contiguous buffers in a single RDMA Write operation (single tagged buffer data transfer), an iWARP initiator (e.g., the data-receiving computing device) may register multiple virtually contiguous buffers with the network adapter 212. In one example, this registration may be performed only once at the start of the application. The iWARP initiator (e.g., the data-receiving computing device) may allocate an ITAG and may write virtually contiguous buffer TAGs, virtual addresses and buffer lengths in the network adapter memory or computing device memory. Further, the iWARP initiator (e.g., the data-receiving computing device) may fill the ITAG in Data Sink STag field, the Data Sink Tagged Offset, and the Data Transfer Length in ULP defined message format in the RDMA Send message. The iWARP initiator may send this message to iWARP responder (e.g., the data-transmitting computing device).

On receiving the RDMA Send message, the iWARP responder (e.g., the data-transmitting computing device) may process the RDMA Send message, and fill the Data Sink Stag, the Data Sink Tagged Offset, and the Upper Layer PDU Length in an RDMA Write PDU. The iWARP responder (e.g., the data-transmitting computing device) may then send one or more RDMA Write PDUs to the iWARP initiator (e.g., the data-receiving computing device).

On receiving the one or more RDMA Write PDUs, the network adapter of the iWARP initiator (e.g., the data receiving computing device) may read ITAG from Data Sink Stag field and may utilize ITAG to fetch virtually contiguous buffer TAGs, virtual addresses and buffer lengths from the network adapter memory or computing device memory, determines direct memory access (DMA) addresses of virtually contiguous buffers and directly places (e.g., via DMA write process) the data into the physical memory mapped to virtually contiguous buffers.

### Direct Data Placement (DDP) Using RDMA Read

For Direct Data Placement (DDP) in multiple virtually contiguous buffers in a single RDMA Read operation (e.g., a single tagged buffer data transfer), the iWARP responder (e.g., the data-receiving computing device) may register multiple virtual contiguous buffers with the network adapter 212. In one example, this registration may be performed only once at the start of the application. The iWARP initiator (e.g., the data-transmitting computing device) may send the Data Source Stag, the Data Source Tagged Offset, and the Data Transfer Length in a ULP defined message format using RDMA Send message. The iWARP initiator (e.g., the data-transmitting computing device) may send this message to the iWARP responder (e.g., the data-receiving computing device). The iWARP responder (e.g., the data-receiving computing device) may process this message, allocate an ITAG, and write virtually contiguous buffer TAGs, virtual addresses, and buffer lengths in the memory of the network adapter 212 or computing device memory (e.g., the RAM 208,). Further, the The iWARP responder (e.g., the data-receiving computing device) may fill the ITAG in Data Sink Stag field, the Data Sink Tagged Offset, the Data Source Stag, the Data Source Tagged Offset, the RDMA Read Message Size in the RDMA Read Request PDU. The iWARP responder (e.g., the data-receiving computing device) may send the RDMA Read Request PDU to the iWARP initiator (e.g., the data-transmitting computing device).

On receiving the RDMA Read Request, the PDU iWARP initiator (e.g., the data-transmitting computing device) may fill the Data Sink Stag, the Data Sink Tagged Offset, and the Upper Layer PDU Length in the RDMA Read Response PDU, and may send one or more RDMA Read Response PDUs to the iWARP responder (e.g., the data-receiving computing device).

On receiving the RDMA Read Response PDU, the network adapter 212 of the iWARP responder (e.g., the data-receiving computing device) may read ITAG from Data Sink Stag field and may utilize ITAG to fetch virtually contiguous buffer TAGs, virtual addresses and buffer lengths from the network adapter memory or computing device memory, determines direct memory access (DMA) addresses of virtually contiguous buffers and directly places (e.g., via DMA write process) the data into the physical memory mapped to virtually contiguous buffers.

### Usage of ITAG for Direct Data Placement(DDP) in NVMe/TCP

In a n NVMe/TCP controller to NVMe/TCP host data transfer and for Direct Data Placement (DDP) in multiple virtually contiguous buffers in a single NVMe Read command (e.g., single tagged buffer data transfer) an NVMe/TCP host (e.g., a data-receiving computing device) may register multiple virtually contiguous buffers with the network adapter 212. This registration may be performed only once at the start of the application. The NVMe/TCP host may allocate an ITAG, and write virtually contiguous buffer TAGs, virtual addresses, and buffer lengths in memory of the network adapter 212 or computing device memory (e.g., the RAM 208).

The NVMe/TCP host may fill the ITAG in Command Identifier (CID) field, and the Data Transfer Length in a CapsuleCmd PDU and may send the CapsuleCmd PDU to the NVMe/TCP controller (e.g., data-transmitting computing device). On receiving the CapsuleCmd PDU, the NVMe/TCP controller may process this PDU, fill the Capsule Command CID, the Data Offset, and the Data Length in a controller-to-host data (C2HData) PDU and send one or more C2HDataPDUs to the NVMe/TCP host. On receiving C2HData PDU, the network adapter 212 of the NVMe/TCP host may read the ITAG from Command Capsule CID field and may utilize the ITAG to fetch virtually contiguous buffer TAGs, virtual addresses and buffer lengths from the network adapter memory or computing device memory. The network adapter 212 of the NVMe/TCP host may determine direct memory access (DMA) addresses of virtually contiguous buffers and directly place (e.g., via DMA write process) the data into the physical memory mapped to virtually contiguous buffers.

### NVMe/TCP Host to NVMe/TCP Controller Data Transfer

For Direct Data Placement (DDP) in multiple virtually contiguous buffers in a single Ready-To-Transfer (R2T) request (e.g., a single tagged buffer transfer), the NVMe/TCP controller (e.g., a data-receiving computing device) may register multiple virtually contiguous buffers with the network adapter 212. This registration may be performed only once at the start of the application.

The NVMe/TCP host (e.g., a data-transmitting computing device) may send a CapsuleCmd PDU with the Write command to the NVMe/TCP controller. The NVMe/TCP controller may process the CapsuleCmd PDU, allocate an ITAG, and write virtually contiguous buffer TAGs, virtual addresses, and buffer lengths in the memory of the network adapter 212 or computing device memory(e.g., the RAM 208). The NVMe/TCP controller may fill the ITAG in Transfer TAG field, the Requested Data Offset, and the Requested Data Length in the R2T PDU, and may send the R2T PDU to the NVMe/TCP host (e.g., data-transmitting computing device).

On receiving the R2T PDU, the NVMe/TCP host may fill the Transfer Tag, the Data Offset, the Data Length in the host-to-controller data (H2CData) PDU and may send one or more H2CDataPDUs to the NVMe/TCP controller.

On receiving the H2CData PDU, the network adapter 212 of the NVMe/TCP controller may read ITAG from Transfer Tag field and may utilize the ITAG to fetch virtually contiguous buffer TAGs, virtual addresses, and buffer lengths from the memory of the network adapter 212 or computing device memory (e.g., the RAM 208). The network adapter 212 of the NVMe/TCP controller may determine direct memory access (DMA) addresses of virtually contiguous buffers and may directly place (e.g., via DMA write process) the data into the physical memory mapped to virtually contiguous buffers.

Usage of ITAG for Direct Data Placement (DDP) in iSCSI

To begin with an iSCSI target to an iSCSI initiator data transfer and for Direct Data Placement (DDP) in multiple virtually contiguous buffers in a single SCSI Read Command (e.g., a single tagged buffer data transfer), an iSCSI initiator (e.g., a data-receiving computing device) may register multiple virtually contiguous buffers with the network adapter 212. In one example, this registration may be performed only once at the start of the application.

The iSCSI initiator allocates an ITAG, writes virtually contiguous buffer TAGs, virtual addresses and buffer lengths in the network adapter memory or computing device memory, fills the ITAG in Initiator Task Tag field and the Data Transfer Length in SCSI Command PDU and sends SCSI Command PDU to iSCSI target (data-transmitting computing device).

The iSCSI target, on receiving a SCSI Command PDU, may process the SCSI Command PDU and fill the Initiator Task Tag, the Buffer Offset, the Data Segment Length in a SCSI at-in Data-In PDU. The iSCSI target may send one or more SCSI Data-In PDU to an iSCSI initiator.

The network adapter 212 of the iSCSI initiator, on receiving the SCSI Data-In PDU, may read the ITAG from Initiator Task Tag field and may utilize the ITAG to fetch virtually contiguous buffer TAGs, virtual addresses, and buffer lengths from memory of the network adapter 212 or computing device memory (e.g., the RAM 208). The network adapter 212 of the iSCSI initiator may determine DMA addresses of virtually contiguous buffers and directly place (e.g., via DMA write process) the data into the physical memory mapped to virtually contiguous buffers.

To continue with an iSCSI initiator to an iSCSI target data transfer and for Direct Data Placement (DDP) in multiple virtually contiguous buffers in a single Ready To Transfer(R2T) request (e.g., a single tagged buffer transfer), the iSCSI target (e.g., a data-receiving computing device) may register multiple virtually contiguous buffers with the network adapter 212. In one example, this registration may be performed only once at the start of the application.

The iSCSI initiator (e.g., the data-transmitting computing device) may send a SCSI Command PDU with a Write command to the iSCSI target. The iSCSI target may process this SCSI Command PDU and allocate an ITAG. The iSCSI target may write virtually contiguous buffer TAGs, virtual addresses, and buffer lengths in the memory of the network adapter 212 or computing device memory (e.g., the RAM 208). The iSCSI target may fill the ITAG in Target Transfer Tag field, the Buffer Offset, and the Desired Data Transfer Length in the R2T PDU and send the R2T PDU to the iSCSI Initiator (e.g., a data-transmitting computing device).

The iSCSI Initiator, on receiving R2T PDU, may process the R2T PDU and fill the Target Transfer Tag, the Buffer Offset, the Data Segment Length in a SCSI Data-Out PDU. The iSCSI Initiator may send one or more SCSI Data-Out PDUs to the iSCSI target.

The network adapter 212 of the iSCSI Target, on receiving the SCSI Data-Out PDU, may read the ITAG from Target Transfer Tag field and may utilize the ITAG to fetch virtually contiguous buffer TAGs, virtual addresses, and buffer lengths from the memory of the network adapter 212 or computing device memory(e.g., the RAM 208). The iSCSI Target may determine DMA addresses of virtually contiguous buffers and directly place (e.g., via DMA write process) the data into the physical memory mapped to virtually contiguous buffers.

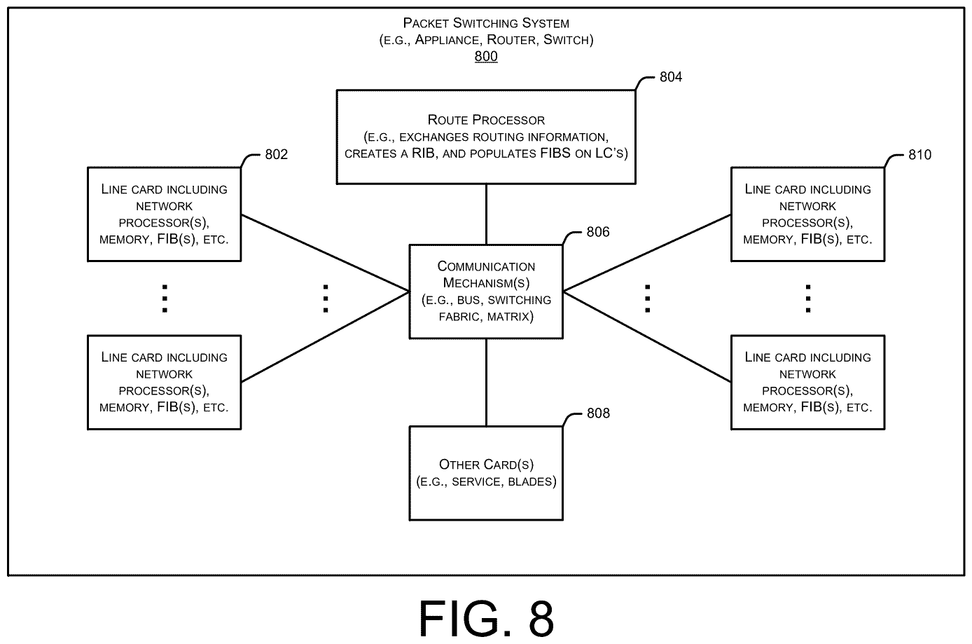

FIG. 8 illustrates a block diagram of an example packet switching device (or system) 800 that can be utilized to implement various aspects of the technologies disclosed herein. In one example, packet switching device(s) 800 may be employed in various networks, such as, for example, any network formed by or between the data-transmitting computing device and the data-receiving computing device exemplified by the computing device 200 and as described with respect to FIGS. 1 and 2.

In one example, a packet switching device 800 may comprise multiple line card(s) 802, 810, each with one or more network interfaces for sending and receiving data packets 300 over communications links (e.g., possibly part of a link aggregation group). The packet switching device 800 may also have a control plane with one or more processing elements for managing the control plane and/or control plane processing of packets associated with forwarding of packets in a network such as a route processor 804 and communication mechanisms 806. The packet switching device 800 may also include other cards 808 (e.g., service cards, blades) which include processing elements that are used to process (e.g., forward/send, drop, manipulate, change, modify, receive, create, duplicate, apply a service) data packets associated with forwarding of data packets in a network. The packet switching device 800 may comprise hardware-based communication mechanism 806 (e.g., bus, switching fabric, and/or matrix, etc.) for allowing its different entities 802, 804, 808 and 810 to communicate. Line card(s) 802, 810 may perform the actions of being both an ingress and/or an egress line card 802, 810, in regard to multiple other particular packets and/or packet streams being received by, or sent from, packet switching device 800.

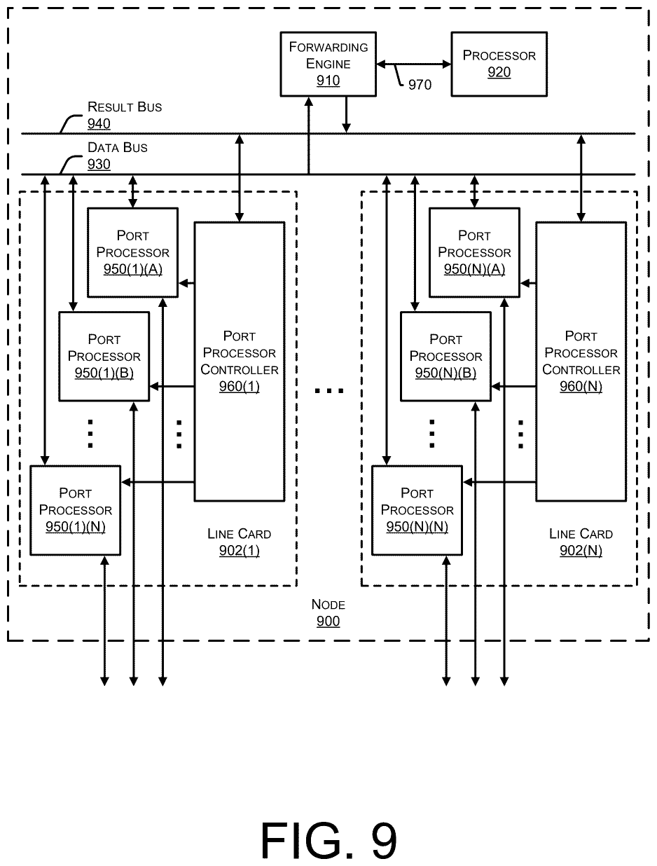

FIG. 9 illustrates a block diagram of components of an example node 900 that may be utilized to implement various aspects of the technologies disclosed herein. In one example, the node(s) 900 may be employed in various networks, such as, for example, any network formed by or between the data-transmitting computing device and the data-receiving computing device exemplified by the computing device 200 and as described with respect to FIGS. 1 and 2.

In one example, node 900 may include any number of line cards 902 (e.g., line cards 902(1)-(N), where N is any integer greater than or equal to 1) that are communicatively coupled to a forwarding engine 910 (also referred to as a packet forwarder) and/or a processor 920 via a data bus 930 and/or a result bus 940. Line cards 902(1)-(N) may include any number of port processors 950(1)(A)-(N)(N) which are controlled by port processor controllers 960(1)-(N), where N may be any integer greater than 1. Additionally, or alternatively, forwarding engine 910 and/or processor 920 are not only coupled to one another via the data bus 930 and the result bus 940, but may also communicatively coupled to one another by a communications link 970.

The processors (e.g., the port processor(s) 950 and/or the port processor controller(s) 960) of each line card 902 may be mounted on a single printed circuit board. When a data packet or data packet and header are received, the data packet or data packet and header may be identified and analyzed by node 900 (also referred to herein as a router) in the following manner. Upon receipt, a data packet (or some or all of its control information) or data packet and header may be sent from one of port processor(s) 950(1)(A)-(N)(N) at which the data packet or data packet and header was received and to one or more of those devices coupled to the data bus 930 (e.g., others of the port processor(s) 950(1)(A)-(N)(N), the forwarding engine 910 and/or the processor 920). Handling of the data packet or data packet and header may be determined, for example, by the forwarding engine 910. For example, the forwarding engine 910 may determine that the data packet or data packet and header should be forwarded to one or more of port processors 950(1)(A)-(N)(N). This may be accomplished by indicating to corresponding one(s) of port processor controllers 960(1)-(N) that the copy of the data packet or data packet and header held in the given one(s) of port processor(s) 950(1)(A)-(N)(N) should be forwarded to the appropriate one of port processor(s) 950(1)(A)-(N)(N). Additionally, or alternatively, once a data packet or data packet and header has been identified for processing, the forwarding engine 910, the processor 920, and/or the like may be used to process the data packet or data packet and header in some manner and/or maty add packet security information in order to secure the packet. On a node 900 sourcing such a data packet or data packet and header, this processing may include, for example, encryption of some or all of the data packet's or data packet and header's information, the addition of a digital signature, and/or some other information and/or processing capable of securing the data packet or data packet and header. On a node 900 receiving such a processed data packet or data packet and header, the corresponding process may be performed to recover or validate information of the data packet or data packet and header information that has been secured.

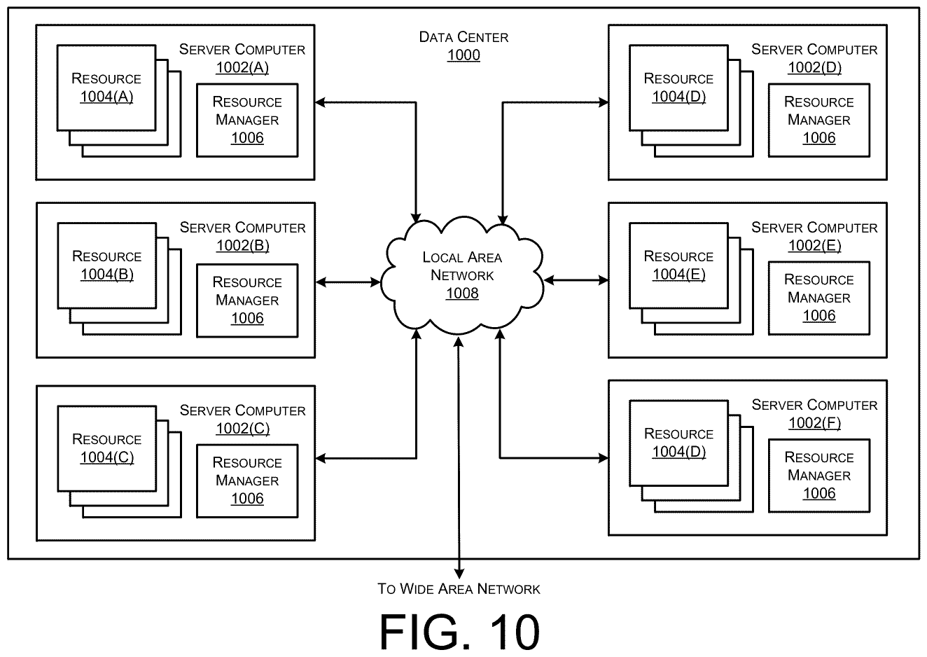

FIG. 10 illustrates a computing system diagram illustrating a configuration for a data center 1000 that may be utilized to implement aspects of the technologies disclosed herein. The example data center 1000 shown in FIG. 10 includes several server computers 1002A-1002F (which might be referred to herein singularly as “a server computer 1002” or in the plural as “the server computers 1002) for providing computing resources. In one example, the computing resources 1004 and/or server computers 1002 may include, or correspond to, any type of networked device described herein such as, for example, the computing device 200 of FIG. 2. Although described as servers, the server computers 1002 may comprise any type of networked device, such as servers, switches, routers, hubs, bridges, gateways, modems, repeaters, access points, etc.

The server computers 1002 may be standard tower, rack-mount, or blade server computers configured appropriately for providing computing resources. In one example, the server computers 1002 may provide computing resources 1004 including data processing resources such as VM instances or hardware computing systems, database clusters, computing clusters, storage clusters, data storage resources, database resources, networking resources, virtual private networks (VPNs), and others. Some of the server computers 1002 may also be configured to execute a resource manager 1006 capable of instantiating and/or managing the computing resources. In the case of VM instances, for example, the resource manager 1006 may be a hypervisor or another type of program configured to enable the execution of multiple VM instances on a single server computer 1002. Server computers 1002 in the data center 1000 may also be configured to provide network services and other types of services.

In the example data center 1000 shown in FIG. 10, an appropriate LAN 1008 is also utilized to interconnect the server computers 1002A-1002F. It may be appreciated that the configuration and network topology described herein has been greatly simplified and that many more computing systems, software components, networks, and networking devices may be utilized to interconnect the various computing systems disclosed herein and to provide the functionality described above. Appropriate load balancing devices or other types of network infrastructure components may also be utilized for balancing a load between data centers 1000, between each of the server computers 1002A-1002F in each data center 1000, and, potentially, between computing resources in each of the server computers 1002. It may be appreciated that the configuration of the data center 1000 described with reference to FIG. 10 is merely illustrative and that other implementations may be utilized.

In one example, the server computers 1002 and/or the computing resources 1004 may each execute/host one or more tenant containers and/or virtual machines to perform techniques described herein.

In one example, the data center 1000 may provide computing resources, like tenant containers, VM instances, VPN instances, and storage, on a permanent or an as-needed basis. Among other types of functionality, the computing resources provided by a cloud computing network may be utilized to implement the various services and techniques described herein. The computing resources 1004 provided by the cloud computing network may include various types of computing resources, such as data processing resources like tenant containers and VM instances, data storage resources, networking resources, data communication resources, network services, VPN instances, and the like.

Each type of computing resource 1004 provided by the cloud computing network may be general-purpose or may be available in a number of specific configurations. For example, data processing resources may be available as physical computers or VM instances in a number of different configurations. The VM instances may be configured to execute applications, including web servers, application servers, media servers, database servers, some or all of the network services described above, and/or other types of programs. Data storage resources may include file storage devices, block storage devices, and the like. The cloud computing network may also be configured to provide other types of computing resources 1004 not mentioned specifically herein.

The computing resources 1004 provided by a cloud computing network may be enabled in one example by one or more data centers 1000 (which might be referred to herein singularly as “a data center 1000” or in the plural as “the data centers 1000). The data centers 1000 are facilities utilized to house and operate computer systems and associated components. The data centers 1000 typically include redundant and backup power, communications, cooling, and security systems. The data centers 1000 may also be located in geographically disparate locations. One illustrative example for a data center 1000 that may be utilized to implement the technologies disclosed herein is described herein with regard to, for example, FIGS. 1 through 9.

While the present systems and methods are described with respect to the specific examples, it is to be understood that the scope of the description is not limited to these specific examples. Since other modifications and changes varied to fit particular operating requirements and environments will be apparent to those skilled in the art, the present systems and methods are not considered limited to the example chosen for purposes of disclosure and covers all changes and modifications which do not constitute departures from the true spirit and scope of this description.

Although the application describes examples having specific structural features and/or methodological acts, it is to be understood that the claims are not necessarily limited to the specific features or acts described. Rather, the specific features and acts are merely illustrative some examples that fall within the scope of the claims of the application.

### CONCLUSION

The examples described herein provide systems and methods that provide for direct data placement (e.g., direct memory access (DMA)) through the utilization of an indirect TAG (ITAG) to ensure reduced CPU overhead, I/O latency and network bandwidth utilization by directly moving data from the wire to multiple virtually contiguous application buffers with no extra data copies being made in a single tagged buffer transfer. An application may register virtually contiguous buffers with network adapter, allocate an ITAG in order to allow for the receiving of data in multiple virtually contiguous buffers in a single tagged buffer data transfer. An ITAG may define an ITAG region which may be defined as special region in network adapter memory or computing device memory. The ITAG region may be divided in variable size units where each unit has an index. This index is used as the ITAG. The application may write a TAG field, a virtual address field, and a length field for all the virtually contiguous buffers in the region. The application may then fill the ITAG, buffer offset and data transfer length in a PDU header of an I/O request and send the PDU to the data-transmitting computing device. The data-transmitting computing device fills the ITAG, buffer offset and data length in each data PDU for the I/O. On receiving a PDU including data, the network adapter uses the ITAG in the protocol header as an index to fetch all the virtually contiguous buffer TAGs, virtual addresses, and buffer lengths from the network adapter memory or computing device memory. Using virtually contiguous buffer TAGs and virtual addresses, the network adapter determines DMA addresses of the application buffers and directly places the data into the application buffers in a single tagged buffer transfer.

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure and covers all changes and modifications which do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

What is claimed is:

1. A non-transitory computer-readable medium storing instructions that, when executed, causes a processor to perform operations, comprising:
registering multiple virtually contiguous buffers with a network adapter;
allocating an indirect TAG (ITAG), the ITAG defining a region within a memory; and
writing virtually contiguous buffer TAGs, virtual addresses and buffer lengths in a memory;
inserting the ITAG, buffer offset and data transfer length into a header of an I/O request packet.

2. The non-transitory computer-readable medium of claim 1, the operations further comprising:
transmitting the I/O request packet to a data-transmitting computing device; and
at the data-transmitting computing device:
inserting ITAG, buffer offset and data length into the header of data packet and transmit one or many data packets to a data-receiving computing device.

3. The non-transitory computer-readable medium of claim 2, wherein transmitting the data packet comprises transmitting the data packet comprising the ITAG, buffer offset, and data length as a single tagged buffer data transfer.

4. The non-transitory computer-readable medium of claim 1, the operations further comprising:
at a data-receiving computing device network adapter utilizing the ITAG as an index, fetching virtually contiguous buffer TAGs, virtual addresses, and buffer lengths from the memory; and
determining direct memory access (DMA) addresses of virtually contiguous buffers to directly place data into physical memory based at least in part on the virtually contiguous buffer TAGs and the virtual addresses.

5. The non-transitory computer-readable medium of claim 1, wherein the region comprises a plurality of variable-size units of the memory.

6. The non-transitory computer-readable medium of claim 5, wherein the plurality of variable-size units comprises an index defining the ITAG.

7. The non-transitory computer-readable medium of claim 1, wherein the ITAG comprises data defining an index to fetch virtually contiguous buffer TAGs, virtual addresses, and buffer lengths from the memory.

8. A computing device comprising:
a network adapter;
a processor communicatively coupled to the network adapter; and
a non-transitory computer-readable media storing instructions that, when executed by the processor, causes the processor to perform operations comprising:
registering multiple virtually contiguous buffers with the network adapter;
allocating an ITAG; writing virtually contiguous buffer TAGs, virtual addresses and buffer lengths in a memory; inserting ITAG, buffer offset and data transfer length into a header of an I/O request packet; transmitting I/O request packet to a data-transmitting computing device; receiving, at the network adapter, a data packet comprising data, an indirect TAG (ITAG), buffer offset and data length within the data packet, the ITAG defining a region within a memory.

9. The computing device of claim 8, further comprising a direct data placement protocol (DDP) module, the operations further comprising, with the DDP module, fetching virtually contiguous buffer TAGs, virtual addresses and buffer lengths from the memory based at least in part on the ITAG, determining direct memory access (DMA) addresses of virtually contiguous buffers to directly place the data into physical memory based at least in part on the virtually contiguous buffer TAGs and the virtual addresses.

10. The computing device of claim 8, wherein the data packet comprises the ITAG, buffer offset, and data length inserted into a header of the data packet by data-transmitting computing device.

11. The computing device of claim 10, wherein receiving the data packet comprises receiving the data packet comprising the ITAG, buffer offset, and data length as a single tagged buffer data transfer.

12. The computing device of claim 8, wherein the ITAG region comprises a plurality of variable-size units of the memory of the network adapter or computing device.

13. The computing device of claim 12, wherein the plurality of variable-size units comprises an index defining the ITAG.

14. The computing device of claim 8, wherein the ITAG comprises data defining an index to fetch virtually contiguous buffer TAGs, virtual addresses, and buffer lengths from the memory of the network adapter or computing device.

15. A network adapter to perform operations comprising:
registering multiple virtually contiguous buffers; allocating an ITAG; writing virtually contiguous buffer TAGs, virtual addresses and buffer lengths in a memory; inserting ITAG, buffer offset and data transfer length into a header of an I/O request packet; transmitting I/O request packet to a data-transmitting computing device; receiving, at the network adapter, a data packet comprising data, an indirect TAG (ITAG), buffer offset, and data length within a header of the data packet, the ITAG defining a region within a memory.

16. The network adapter of claim 15, further comprising a direct data placement protocol (DDP) module, the operations further comprising, with the DDP module, fetching virtually contiguous buffer TAGs, virtual addresses and buffer lengths from the memory based at least in part on the ITAG, determining direct memory access (DMA) addresses of virtually contiguous buffers to directly place the data into physical memory based at least in part on the virtually contiguous buffer TAGs and the virtual addresses.

17. The network adapter of claim 15, wherein the data packet comprises the ITAG, buffer offset and data length inserted into a header of the data packet by data-transmitting computing device.

18. The network adapter of claim 15, wherein transmitting the data packet comprises transmitting the data packet comprising the ITAG, buffer offset, and data length as a single tagged buffer data transfer.

19. The network adapter of claim 15, wherein the ITAG region comprises a plurality of variable-size units of the memory of the network adapter or computing device.

20. The network adapter of claim 19, wherein the plurality of variable-size units comprises an index defining the ITAG.

21. The network adapter of claim 15, wherein the ITAG comprises data defining an index to fetch virtually contiguous buffer TAGs, virtual addresses, and buffer lengths from the memory of the network adapter or computing device.

22. The network adapter of claim 15, wherein the ITAG is utilized by iWARP, iSCSI and NVMe/TCP for Direct Data Placement into multiple virtually contiguous buffers in a single tagged buffer transfer.
